(19) United States
(12) Patent Application Publication
(10) Pub. No.: US 2003/0120923 A1
(43) Pub. Date: Jun. 26, 2003

(54) Secure data authentication apparatus

(75) Inventors: Robert R. Gilman, Broomfield, CO (US); Richard L. Robinson, Broomfield, CO (US); Douglas A. Spencer, Boulder, CO (US)

Correspondence Address: PATTON BOGGS, PO BOX 270930, LOUISVILLE, CO, 80027, US

(73) Assignee: Avaya Technology Corp.

(21) Appl. No.: 10/028,004

(22) Filed: Dec. 21, 2001

(51) Int. Cl. H04L 9/00

(52) U.S. Cl. 713/170

(57) ABSTRACT

A secure data authentication apparatus for authenticating the source of a software file for use on a computer system having a secure processing device. The secure data authentication apparatus further authenticating an owner of the software file and authenticates that the owner of the software file is the owner of the computer system that the software file is being installed on. The software file comprising a first source signature and a unique owner signature. The secure processing device generating a second source signature and a second owner signature, wherein if the first and second source signatures match and first and second owner signatures match, the computer system operates accepts the software file as being authenticated for the owners use and from the source represented by the first source signature.

### FIELD OF THE INVENTION

The invention relates to software security, and in particular, to an apparatus to securely authenticate the source of telephony switching software and the owner of the software and to authenticate that the owner of the software matches the owner of the telephony switching system and that only those features purchased by the owner are authorized for use.

### Problem

It is a problem in the field of software to provide software programs that can be installed by the software owner while also providing an apparatus to prevent an unauthorized user from installing the software on another computer system without paying for it. A second problem, particularly in the field of telephony switching software is to provide a secure key for authenticating the source and owner of the telephony switching software while preventing an unauthorized individual, or hacker, from obtaining the key and using the key to make unauthorized changes to the software file.

The problem of securing software from unauthorized use is a common problem throughout the computer industry. Three methods for addressing the problem involve using a key to access or enable the software including the use of a static encrypted password, use of a software key or a hardware key. The first method includes a static password or “key” that is encrypted and stored in memory. The user must enter his user name and password, which are compared and verified against a password file which may be, in whole or part, encrypted.

Encrypted Password

A security mechanism for computer equipment described by Thompson, (application Ser. No. 09/454,625) uses an encrypted password and a stored encryption key to validate the user's authorization to access the computer. When the computer is booted, the security routine executes first and prompts the user for a password, encrypts the password with the stored key, and compares the result with an encrypted form of the correct password that is stored in memory. If the encrypted passwords do not match, the boot is aborted and the computer is disabled.

However, unauthorized individuals familiar with software coding can find the key and encrypted password in memory, decrypt or alter it, and then use the password to gain use of the software or computer. The security mechanism just described fails to provide an apparatus for securely storing the key within the computer equipment to prevent a hacker from obtaining and using the key to access the computer system.

Software Key

A known method for distributing software for installation by the user utilizes a CD-ROM with a key that must be entered to enable the software program. This does not solve the problem of unauthorized use of upgraded software versions since the CD-ROM is usually distributed with the key. Once distributed to a user, there is no method to prevent the upgraded software from being installed on other systems even though it is illegal.

Another method includes providing a customer with software on a CD-ROM disk and a program on the CD-ROM disk that automatically connects to a remote server via the Internet to receive a machine-specific key. The key unlocks the software so that it can be utilized on the computer. The remote server first obtains the necessary payment information from the computer user.

Utilizing an automatic Internet connection to obtain a key to unlock the software has been taken a step further with a security method that identifies eight unique details about the computer that is calling, such as the first time the trashcan was used. Every time the application is accessed, the software first verifies that the computer has a contract. If the eight unique details do not match, the computer on which the software is installed does not have a contract and access is denied.

The security methods just described fail to provide a method to prevent a hacker from accessing and using the key or accessing and changing the eight unique details. The security system may be adequate for software having a minimal cost, however, telephony switching software and feature activation is not minimal. The potential benefit from reselling pirated telephony software may provide the incentive for an unauthorized hacker to breach the security of the system.

Hardware Key

Another method includes the use of a special piece of hardware attached to the system for authorizing an individual. The hardware, referred to as a “dongle”, connects to a serial or parallel port of the computer. The software operating on the computer sends a random number to the dongle. The dongle performs a computation and sends the result to the computer that performs a corresponding computation. If the two computations match, the software continues to run.

The apparatus just described fails to verify that the requester is an authorized user of the software. Another problem with the dongle is that it is hardware and hardware fails. When the dongle fails, the system is down until a new one can be obtained. Use of a dongle to change telephony switching system features requires a technician with the hardware to travel to the customer's site. Requiring an on-site technician to administer changes or to install an upgraded software version is costly and takes an increased amount of time. Additionally, some dongles are susceptible to a “man-in-the-middle” attack. In such an attack, the hacker “listens” to the communication between the computer and the dongle then “replays” the communication without the dongle for future access.

A third problem arises when a software program includes a set of features wherein the customer selects and pays for a subset of the features. It is an ongoing problem to prevent unauthorized individuals that illegally obtain the access key from activating additional features that the customer has not paid for while also providing a method to enable and disable features.

Within the telephony industry, these problems have been addressed by using passwords that only allow authorized users to have access to the telephony switching system for enabling or disabling features or installing new software versions. The entered password is compared to the password stored in the customer's switching system. If the passwords match, the authorized user is granted access to change features or to install a new software version. This method fails to prevent individuals with knowledge of software from locating the stored static password and using it to gain unauthorized access and to enable features that have not been paid for.

A more secure method of authorizing access to a computer or telephony switching system is to encrypt information under a key using a standard encryption algorithm, such as that described by the Data Encryption Standard (DES) or Advanced Encryption Standard (AES), and then break the encryption key into a plurality of segments and storing each segment in a different memory location. It is a problem with encrypted passwords to prevent a hacker from obtaining the key. Breaking the key into segments is not random. Once the key is located, a hacker has the ability to use the standard encryption algorithm to decrypt the encrypted data, including passwords and feature files. Many standard encryption algorithms are symmetrical; therefore, the hacker can apply the algorithm in reverse to decrypt the key.

Periodic Inquiry

In the field of telephony switching systems, another method of preventing a customer from activating a feature that has not been paid for is described by Serkowski, (application Ser. No. 09/357,679). In Serkowski, the telephony switching manufacturer or seller periodically sends an encrypted message to a licensed system to obtain the serial number of the microprocessor resident in the system, identify the version of software running on the system, and obtain a list of activated features. The information received from the telephony switching system is compared to the customer's stored license file. If there is a discrepancy in serial number or software version, the telephony switching system is not permitted to run. If the serial number and software version match, an encrypted message is sent to the telephony switching system granting it permission to run and listing the permitted features.

A problem with the telephony security system just described is that it requires access to the customer's telephony switching system. Warranty customers and customers with on-going maintenance agreements with the manufacturer provide remote access, however, the manufacturer does not have remote access to customer systems that are not maintained by the manufacturer. This limits the number of telephony switching systems the manufacturer can query, thus lacking the ability to prevent non-maintenance customers from using pirated software or activating and using features that have not been paid for.

Software security features utilizing a key to encrypt and decrypt a password fail to prevent an unauthorized individual from accessing the key and using the key to breach the security of the system. Likewise, the hardware solution fails to prevent an unauthorized individual from attacking the system to gain unauthorized access.

For these reasons, a need exists for a secure data authentication apparatus that prevents unauthorized access to the software and that authenticates the source of the software and the owner of the software and the computer system that the software will be utilized on.

### Solution

The present secure data authentication apparatus overcomes the problems outlined above and advances the art by providing an apparatus for authenticating the source of the software file being installed and to verify that the owner of the software file is the owner of the equipment the software file is being installed on. While the present secure data authentication apparatus can be utilized with a variety of hardware equipment and software files, telephony switching equipment and telephony software files will be used to describe the features of the present secure data authentication apparatus.

The present secure data authentication apparatus provides a method for authenticating the source of a software file and the owner of the software file and the telephony switching system the software file is being installed on. The software file includes a source signature and an owner signature appended to the software file. A secure microprocessor located within the owner's telephony switching equipment includes an encryption algorithm, a security routine, a source key and a unique owner key that are used by the secure microprocessor to calculate a source signature and a unique owner signature for each software file or downloaded image. The secure microprocessor compares the calculated source and owner signatures to the source and owner signatures appended to the end of the software file or images. If the signatures match, installation and use is authorized. If the signatures do not match, the software file cannot be installed and the telephony switching system may be disabled.

Computer Equipment and Software Source

At the source, at least a portion of the software file to be installed is “hashed” to generate a hash value. Hash functions have been used in the computer science industry for a long time. A hash function is a non-invertable function, mathematical or otherwise, that takes a variable length digital input string and converts it to a strongly collision-free, fixed length digital output string called a hash value. Hash functions are considered strongly collision-free if it is computationally infeasible to find different input strings that generate the same hash value. Hash functions are considered one-way or non-invertible if the input string cannot be determined from the output string. Hash functions described hereon are presumed to be one-way and strongly collision-free. The hash value and a unique owner key are used to calculate a unique owner signature when the hash value is encrypted with the unique owner key and to calculate a source signature when the hash value is encrypted with the source key. The benefit of creating a unique owner signature to append to the installation software is to prevent unauthorized individuals that obtain the software file in an unscrambled form from using the software file without authorization. Once calculated, the source signature and/or unique owner signature are appended to the software file.

User Telephony Switching System

The owner's telephony switching system comprises a commercially available secure microprocessor. The secure microprocessor comprises a processor, a memory, and 1/0 features. In addition, the secure microprocessor incorporates a sophisticated security feature including an array of mechanisms designed to resist all levels of threat, including observation, analysis, and physical attack of the secure microprocessor. Prior to installation of the new software file, the telephony switching system processor or the secure microprocessor chip hashes at least a portion of the software file using the same hash function as the source used to derive the hash value. The secure microprocessor includes the same algorithm to encrypt the hash value with the source and/or owner key to generate a second source and/or a second owner signature. The second source signature and/or second owner signature is then compared to the appended source signature and/or appended owner signature. If the signatures match, a signal is sent to the telephony switching system processor authorizing the installation and/or use of the software file.

The secure data authentication apparatus provides a method for each copy of the software file to contain a unique set of signatures and for each telephony switching system to contain a secure microprocessor including a unique set of keys that cannot be compromised. Providing a secure microprocessor chip that securely stores the encryption algorithm, a security routine, and a source and unique owner key prevents a hacker from accessing the source and owner keys and using the keys to compromise the software program or to install the software file on other telephony switching systems without paying for additional use. It also prevents an unauthorized individual from removing the encrypted signatures since the telephony switching system will not operate without first authenticating the source and the owner.

The secure data authentication apparatus just described overcomes the problem of authenticating the source of the software file installed on an owner's telephony switching system. It also provides a secure microprocessor to store a unique owner key to generate a unique owner signature for authenticating the ownership of the software file and the telephony switching system. Providing an apparatus to authenticate the owner of the software file and the telephony switching system prevents installing the software file on another telephony switching system without paying for the software file.

### BRIEF DESCRIPTION OF THE DRAWINGS

FIG. 1 illustrates a block diagram of the present secure data authentication apparatus;

FIG. 2 illustrates a flow diagram of a method of utilizing the present secure data authentication apparatus to generate a first source signature and a first owner signature;

FIG. 3 illustrates a flow diagram of a method of utilizing the present secure data authentication apparatus to authenticate the first source signature and the first owner signature; and

FIG. 4 illustrates a flow diagram of an embodiment of the present secure data authentication apparatus.

### DETAILED DESCRIPTION

The present secure data authentication apparatus summarized above and defined by the enumerated claims may be better understood by referring to the following detailed description, which should be read in conjunction with the accompanying drawings. This detailed description of the preferred embodiment is not intended to limit the enumerated claims, but to serve as a particular example thereof. In addition, the phraseology and terminology employed herein is for the purpose of description, and not of limitation.

Software developers provide software files for installation on customer owned equipment. Once the software file is purchased, it is a problem to prevent unauthorized loading of the software file on other computers. The present secure data authentication apparatus provides a method for identifying the owner of the software file and verifying that the owner of the software file is also the owner of the equipment the software file is being installed on. While the present secure data authentication apparatus can be utilized with a variety of hardware equipment and software files, telephony switching equipment and telephony software files will be used to describe the features of the present secure data authentication apparatus.

Customer telephony equipment is often called a Private Branch Exchange, or simply PBX. In the United States a PBX refers generically to any telephony switching system owned or leased by a business or organization to provide both internal switching functions and access to the public network. PBX equipment includes additional features that can be purchased by the PBX owner. The present secure data authentication apparatus is described for a PBX having a plurality of additional features that the PBX owner can pay to have activated. Features that are not purchased by the PBX owner are not activated.

Additional features include echo cancellation, attendant vectoring for routing calls to the attendant, emergency call to the attendant, and others. When a PBX is purchased, the features paid for by the PBX owner are activated and a list of features, called a feature file, is installed on the customers PBX. Later the owner may have additional features activated or deactivated. In the prior art, the telephony equipment manufacturer used a key to access the owner's encrypted feature file to activate or deactivate features. It has been an ongoing problem in the field of telephony switching systems to prevent unauthorized individuals from activating features that the owner has not paid for. It is also a problem in the telephony switching systems field to prevent an owner having a plurality of PBX systems from paying for additional features on one PBX and installing the software file containing the additional features on other systems owned by the same customer.

The present secure data authentication apparatus provides a method for verifying the source of a new software file prior to installation on a customer's PBX and to confirm that the PBX that the software file is being installed on is the software file owner's PBX. Thus, preventing a software file containing a feature file that is owned by one customer from being installed on another customer's PBX. The present secure data authentication apparatus also provides a method for identifying the PBX equipment owner to prevent the owner from installing the software file on other equipment without paying for the enabled features or upgraded software file.

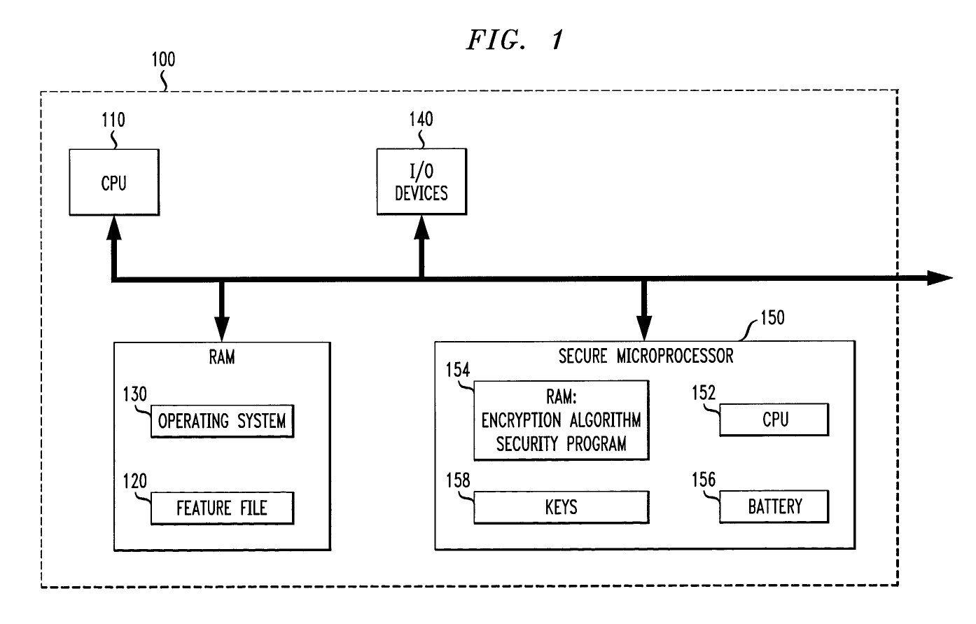

Referring to FIG. 1, the apparatus comprises a secure microprocessor 150 integral to the customer's telephony switching system processing board 100 with one or more authorization keys 158, a source key and an owner key in this example, programmed into the secure microprocessor 150. The secure microprocessor 150 includes firmware for performing an encryption algorithm to verify the source and/or the owner of the software file prior to installation.

In an embodiment of the secure data authentication apparatus, the secure processor also verifies that the PBX the new software file is being installed on belongs to the same customer that owns the software file being installed. If the PBX owner does not match the software file owner, the PBX processor informs the customer that the software file cannot be installed and aborts operation.

A variety of secure microprocessors are commercially available such as the Dallas Semiconductor DS5002FP secure microprocessor chip. Secure microprocessor 150 comprises a central processing unit (CPU) 152 for controlling the operation of the secure microprocessor and random access memory 154 for storing an encryption algorithm, an execution program and a plurality of keys 158. Secure microprocessor 150 also includes a battery 156 to maintain the security feature when the secure microprocessor is not powered from an external source. The encryption algorithm, execution program and keys within RAM 154 are encrypted and converted to battery backed storage. As a result, the contents of the memory and the execution software appear unintelligible to an outside observer. Any attempt to discover the key results in its erasure, rendering the encrypted contents of RAM useless.

The security feature of the secure microprocessor chip includes an array of mechanisms that are designed to resist all levels of threat, including observation, analysis, and physical attacks. The secure microprocessor security feature includes a self-destruct input pin that interfaces with an external tamper detection circuitry. When the external input pin is not being used, additional sensors within the secure microprocessor will detect if the secure microprocessor is being tampered with. As a result, a massive effort would be required to obtain any information about the memory content. Providing a secure microprocessor within the PBX provides a level of security that requires more time and resources to defeat than it is worth to an unauthorized individual.

Secure microprocessor 150 provides a method for initially programming an execution program and a plurality of pre-selected keys and can be configured to incorporate a one-of a-kind encryption algorithm. The pre-selected keys 158 located in memory within secure microprocessor 150 are used to encrypt a hash value. The execution program programmed into the secure microprocessor computes at least one signature and compares the computed signature to an signature that is appended to the software file being installed or run on the PBX. In the present example, the keys include a source key and an owner key and the signatures include a source signature and a owner signature.

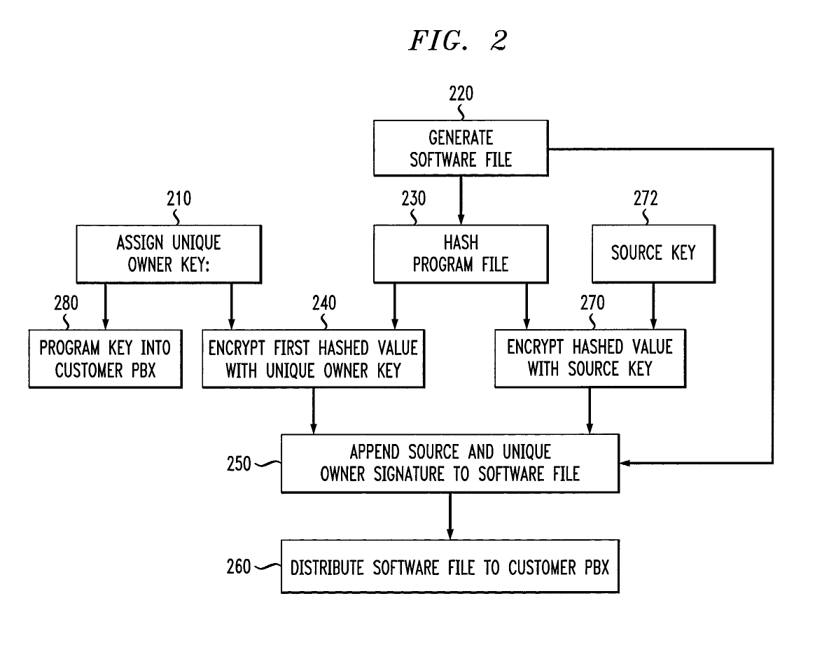

PBX and Software Source—FIG. 2:

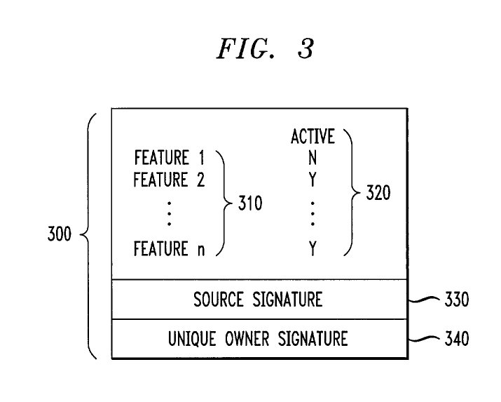

Referring to the flow diagram in FIG. 2, the source is the PBX manufacturer that includes a secure customer equipment distribution center that assigns a unique owner key to each customer in block 210. Providing at least one unique owner key for each customer provides a method for distributing a PBX containing the unique owner key to the specific customer in block 280. It also provides a method for using the unique owner key assigned in block 210 to generate a unique owner signature that is appended to software file delivered to the customer for use with the specific PBX programmed in block 280. The PBX manufacturer, or source, also generates a software file in block 220 that is unique to the PBX owner. Referring to FIG. 3, software file 300 may be a list of features 310 wherein features 310 that the owner has purchased are activated 320 or may be an upgraded software version that the specific PBX owner has paid for.

Referring to FIGS. 2 and 3, to overcome the problem of a customer installing a purchased feature file 310 or upgraded software file version on more than one PBX, the distribution center assigns a unique owner key to each customer in block 210. Alternatively, assigning a set of unique owner keys for one customer that owns more than one PBX enables the source to attach a unique owner signature 340 to each software file 300 supplied to the customer, thus preventing software file 300 from being installed on any PBX other than the specific PBX for which it was purchased.

Referring back to FIG. 2, hashing at least a portion of the software file to generate a first hash value in block 230 generates the first unique owner signature when encrypted in block 240 with the unique owner key assigned in block 210. Hash functions have been used in the computer science industry for a long time. A hash function is a function, mathematical or otherwise, that takes a variable length string of data and converts it to a fixed length digital output string called a hash value.

The hash value is encrypted with the first owner key in block 240 to produce a first owner signature. The first owner signature from block 240 is then appended to the software file from block 220 that was used in block 230 to generate the hash value. Utilizing at least a portion of the software file to generate the hash value provides a method for the PBX manufacturer to append a unique owner signature to each software file supplied to the customer. Referring again to FIGS. 2 and 3, software file 300 previously described contains a feature file, or list of features 310, that the PBX owner has purchased. Hashing the owner's feature file 310 to generate a first hash value in block 230 and encrypting the first hashed value with the owner's unique key from block 210 generates a first owner signature 340 in block 240 that is appended only to that owner's software file 300 in block 250. Generating and appending first owner signature 340 in blocks 240 and 250 respectively, to each software file 300 from block 220 to be distributed to the PBX owner in block 260 prevents an unauthorized individual from appending the same owner signature 340 from software file 300 to another software file.

In an embodiment of the present secure data authentication apparatus; the first hash value from block 230 is encrypted with source key 272 to produce a first source signature 330 in block 270 that is also appended to software file 300 in block 250. Software file 300 with the appended first owner signature 340 from block 240 and the first source signature 330 from block 270 is distributed to the PBX owner in block 260.

The customer's PBX includes an operating system that initially authenticates the source of the software file installed on the PBX and the owner of the software file and the owner of the PBX. The present secure data authentication apparatus accomplishes this task by providing a unique secure microprocessor within each PBX delivered to the customer.

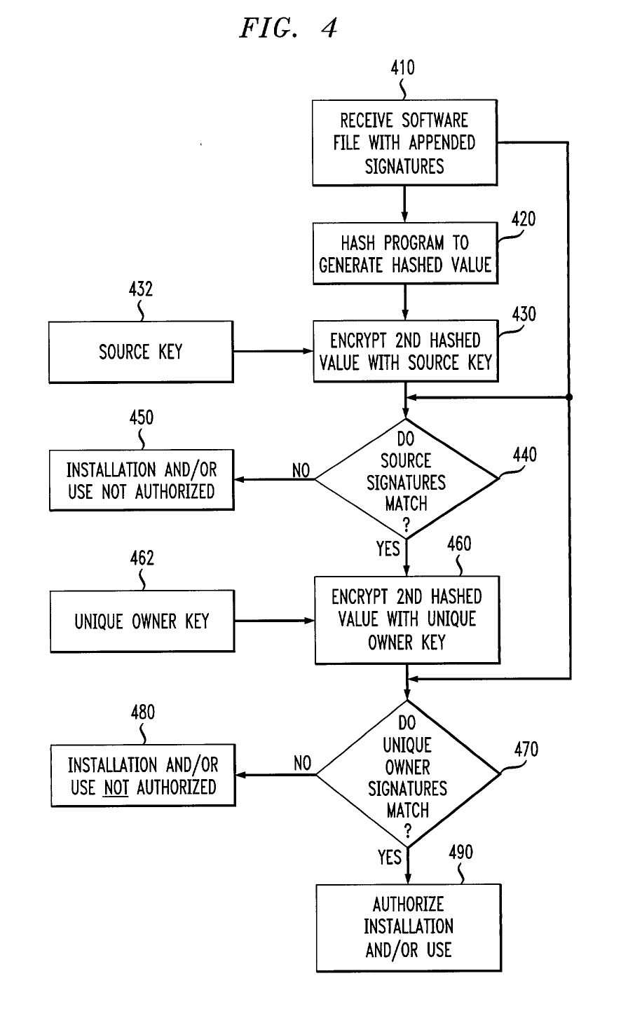

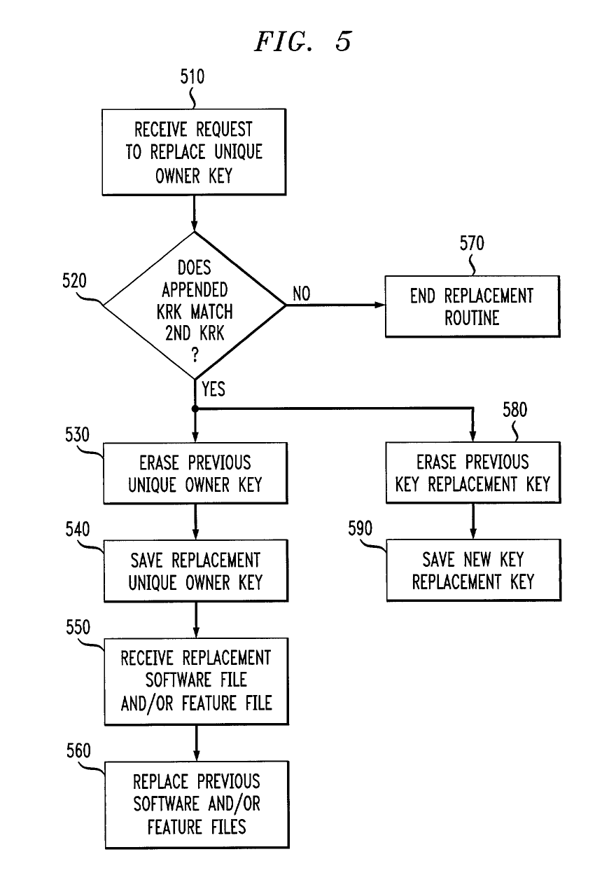

Source Authentication—FIGS. 2 and 4:

A generic PBX includes a processor board that executes the operating system, thus controlling the customer's internal switching functions and access to the public network. The present secure data authentication apparatus further comprises a unique secure microprocessor having a security routine, an encryption algorithm and a unique set of keys. The set of keys provide a method for the PBX manufacturer, the source in this example, to authenticate the source of the software file and the owner of the software file and the PBX prior to installation and/or execution of the software files on PBXs in the field.

Referring to the flow diagrams in FIGS. 2 and 4, in block 410 the software file is received from the source via an I/O device such as a modem for remotely downloading the software to the PBX or a CD ROM delivered to the PBX owner and installed via a CD drive. The secure microprocessor hashes the same portion of the software file in block 420 as the source distribution center hashed in block 230 to generate a second hash value. The second hash value is encrypted in block 430 with the source key 432 stored within the secure microprocessor to generate a second source signature. The encryption algorithm within the secure microprocessor is the same encryption algorithm used at the source distribution center to encrypt the first hash value with the same source key 272 to generate the first source signature in block 270 that is appended to the software file in block 250. Providing an apparatus to securely hash the same portion of the software file in block 420 and encrypt that second hash value with the same source key 432 in block 430 generates the same source signature. If the portion of software file or the source key used to generate the source signature is not the same, a different source signature results. Asymmetric encryption algorithms may also be used. If asymmetric encryption algorithms are used, the source signatures can be validated without being reproduced. In this embodiment, the secure microprocessor need not reproduce the signatures. Instead, the customer's private key is used to validate the owner signature appended to the software file. Similarly, the source signature appended to the software file is validated by the secure microprocessor using a source public key.

In block 440, the secure microprocessor compares the second source signature from block 430 with the appended source signature from block 250. If the signatures do not match, installation and use of the software file is not authorized in block 450 since the source of the software file cannot be authenticated. If the signatures match, the secure microprocessor computes a second owner signature and compares it to the first owner signature from block 240 that is also appended in block 250 to the software file.

Software File and PBX Owner Authentication—FIG. 4:

Referring again to FIG. 4, as previously discussed, the second hash value from block 420 is next encrypted with the owner key 462 stored within the secure microprocessor to generate a second owner signature in block 460. The secure microprocessor compares the second owner signature with the appended first owner signature in block 470. If the first and second owner signatures match, a signal is sent to the PBX processor in block 490 authorizing the software file to be installed and to operate. If the signatures do not match, installation and use of the software file is not authorized in block 480.

When the PBX is reinitialized, the security routine located within the secure microprocessor executes first and checks the source of the software files and authenticates that the owner of the software files is the owner of the equipment on which the software files are installed. Continuously authenticating the source of the software files and the owner of the PBX prevents an individual from installing and running a “bootlegged” or “counterfeit” software file on the PBX.

Software Upgrades and/or Feature File Changes—FIGS. 2 and 5:

As enhancements in telephony are developed or additional features are added, the PBX manufacturer sells an updated version of the PBX software file at a cost to the customer. Likewise, the customer may request changes to the customer's feature file. In the prior art, an authorized individual with the correct password accessed the customer's encrypted feature file to activate or deactivate features. When a customer ordered an upgraded software version, a CD-ROM was sent to the customer or the upgraded version of software was downloaded from the PBX source to the customer's PBX. Once the customer received the upgraded software file, there was no apparatus or method to prevent the software file from being installed on other PBX equipment. Likewise, other than encryption of the feature file, no security feature prevented an unauthorized individual from discovering the encryption key and activating features that the customer did not pay for.

The present secure data authentication apparatus provides a method for the PBX manufacturer to create a new feature file or upgraded software file and append a source and owner signature to the file. The enhanced feature file or upgraded software version with the appended signatures can be delivered to the customer via secure or insecure channels since appendage of the source and owner signatures prevents others from installing or using the software file. Thus, the present secure data authentication apparatus provides a method for upgrading a particular PBX while also preventing the upgraded software file from being installed or used on other PBX equipment.

Referring back to FIGS. 2 and 4, the PBX manufacturer maintains a record of unique owner keys assigned in block 210. When a customer purchases an upgraded software file or additional features for use on a PBX owned by that customer, a unique source signature is generated in block 270 using a new hash value generated by hashing the upgraded software file or new feature file in block 230. Likewise, a unique owner signature is generated in block 240 and the two signatures are appended in block 250 to the purchased upgraded software file or new feature file. As previously discussed, prior to installation on the customer's PBX, the appended first source signature and first owner signature are compared in blocks 440 and 470 against a second source signature and second owner signature generated in blocks 430 and 460 by the secure microprocessor.

Appending a unique source signature and owner signature to each software file purchased by the customer prevents installation of the software file on any other PBX. Generating a hash value from the software file and/or feature file and encrypting the hash value with the source key to produce the source signature prevents an unauthorized individual, or hacker, from successfully modifying the software file having the appended source signature. If a hacker modifies the software file or feature file, the secure microprocessor will generate a different hash value, resulting in a second source signature that does not match the appended first source signature.

Key Replacement—FIG. 5:

In today's business environment, it is not unusual for one business to be consolidated into another business. In this event, the customer may request a unique customer key identifying the new business. Likewise, it is possible for one customer to sell his PBX to another customer and request that the unique customer key be replaced to identify the new owner. The unique customer key within the secure microprocessor can be erased and a replacement unique customer key added.

To prevent an unauthorized individual from replacing an owner key, the secure microprocessor in this embodiment includes a customer unique key exchange key. Referring to FIG. 5, the firmware programmed into the secure microprocessor by the PBX manufacturer provides a routine for receiving a request in block 510 for replacing the unique owner key. The request identifies the key replacement key and if it matches the stored key replacement key in decision block 520, the routine erases the previously stored unique owner key in block 530 and saves the replacement unique owner key in block 540. The replacement process illustrated in FIG. 5, can be completed by downloading the program file from a remote location or by a technician at the customer premise.

After the unique owner key has been replaced in blocks 430 and 540, the PBX source downloads a replacement feature file in block 550 with a corresponding replacement owner signature appended. The replacement feature file overwrites the previously stored feature file in block 560. Likewise, any other software file containing the previous owner signature is replaced in blocks 550 and 560 with a replacement software file having the replacement owner signature appended. In an embodiment of the present secure data authentication apparatus, the key exchange key is also erased in block 580 and a new key replacement key may be saved in block 590 to correspond to the replacement owner key saved in block 540. In another embodiment, the unique owner key is replaced in blocks 430 and 540 and the key exchange key is not replaced.

As previously discussed, when the PBX is reinitiated, the PBX operating system executes and checks the source of the software files and authenticates that the owner of the software file is the owner of the PBX on which the software file is installed. Replacement of the software files with replacement owner signatures provides a method for continuously authenticating the source of the software file and the owner of the PBX and software files. Continuously authenticating the source of the software files prevents an individual from installing and running a “bootlegged” or “counterfeit” software file on the PBX. Likewise, comparing a second owner signature generated by the secure microprocessor with the appended first owner signature prevents one PBX owner from using software and/or features files owned by another PBX owner.

Security Features

Installing the security routine, encryption algorithm, and keys within the secure microprocessor prior to delivering the PBX to the customer provides an additional level of security. Likewise, executing the security routine and encrypting the hash value within the secure processor prevents unauthorized individuals from bypassing the security check when the PBX is initialized and prevents a hacker from accessing the keys or from determining the encryption algorithm used to generate the signatures.

Software stored within the secure microprocessor is provided the same level of security as saved keys. The secure microprocessor loads and executes the security routine and encryption algorithm in encrypted form. The encrypted security routine, encryption algorithm and keys are stored in nonvolatile storage. Loading the software is accomplished utilizing a Bootstrap Loader. Once the security routine, encryption algorithm and keys have been loaded the security lock is set. Loading is only possible when the lock is clear. If the security lock has been previously set, resetting the security lock instantly clears the previous contents of RAM and writes Os into the first 32k of external RAM.

Storing and executing the security routine and encryption algorithm within the secure processor prevents a hacker from accessing the internally stored data while providing an apparatus that allows the PBX source to update the security routine, encryption algorithm, and the unique set of keys. Thus, the present secure data authentication apparatus requires more time and resources to defeat than it would be worth to an unauthorized individual.

As to alternative embodiments, those skilled in the art will appreciate that the present secure data authentication apparatus may be utilized to authenticate the source of software files running on a variety of computer equipment and/or confirm that the owner of the computer equipment is the owner of the software file. While the present secure data authentication apparatus has been described for telephony switching system, it can be utilized on a variety of computer equipment to prevent unauthorized distribution and installation of software files.

It is apparent that there has been described a secure data authentication apparatus that fully satisfies the objects, aims, and advantages set forth above. While the secure data authentication apparatus has been described in conjunction with specific embodiments thereof, it is evident that many alternatives, modifications, and/or variations can be devised by those skilled in the art in light of the foregoing description. Accordingly, this description is intended to embrace all such alternatives, modifications and variations as fall within the spirit and scope of the appended claims.

What is claimed is:

1. A secure data authentication apparatus to authenticate a software file, the software file having a first signature appended to the software file, for use on a computer system, the apparatus comprising:
a secure processing device within the computer system to receive the software file and hash the software file to produce a first hash value; and
a first key located within the secure processing device, wherein the secure processing device encrypts the first hash value with the first key to generate a second signature and compares the first signature with the second signature and if the first signature matches the second signature the computer system accepts the software file as being authenticated.

2. The secure data authentication apparatus of claim 1 wherein the software file further comprises a first source signature appended to the software file, the apparatus further comprising:
a source key located within the secure processing device, wherein the secure processing device encrypts the first hash value with the source key to generate a second source signature and compares the first source signature with the second source signature, and if the first source signature matches the second source signature the computer system accepts the software file as being authenticated from the source represented by the first source signature.

3. The secure data authentication apparatus of claim 1 wherein the software file further comprises a first owner signature appended to the software file, the apparatus further comprising:
an owner key located within the secure processing device, wherein the secure processing device encrypts the first hash value with the owner key to generate a second owner signature and compares the first owner signature with the second owner signature, and if the first owner signature matches the second owner signature the computer system accepts the software file as being authenticated.

4. The secure data authentication apparatus of claim 1, further comprising:
a key exchange request having a first key exchange signature appended thereto, the key exchange request sent from the computer system to the secure processing device, wherein the secure processing device hashes the key exchange request to generate a second hash value;
a first key exchange key located within the secure processing device, wherein the secure processing device encrypts the second hash value with the first key exchange key to generate a second key exchange signature and compares the first key exchange signature with the second key exchange signature, and if the first key exchange signature matches the second key exchange signature the secure processing device erases the first owner key; and
a second owner key within the key exchange request, wherein the secure processing device saves the second owner key.

5. The secure data authentication apparatus of claim 4, wherein the computer system further comprises a first feature file and the computer system performs in accordance with the first feature file, the apparatus further comprising:
a second feature file having a third owner signature appended thereto, wherein the secure processing device hashes the second feature file to generate a third hash value which is encrypted with the second owner key to generate a fourth owner signature and compares the third owner signature with the fourth owner signature and if the third owner signature matches the fourth owner signature the computer system replaces the first feature file with the second feature file.

6. The secure data authentication apparatus of claim 1, wherein the program comprises a feature file having a plurality of features wherein a subset of the plurality of features are activated and the computer system operates in accordance with the subset of the plurality of features.

7. A secure data authentication apparatus to authenticate an owner of a software file and of a telephony switching system on which the software file is stored, the apparatus comprising:
a first feature file and a software file, the first feature file having a plurality of features and a first owner signature appended thereto, wherein a first subset of the plurality of features is activated;
a secure microprocessor within the telephony switching system, the secure microprocessor having an encryption algorithm, wherein the secure microprocessor hashes the first feature file to generate a first hash value; and
a first owner key with in the secure microprocessor, wherein the secure microprocessor encrypts the first hash value with the first owner key to generate a second owner signature and the secure microprocessor compares the first owner signature with the second owner signature and if the first owner signature matches the second owner signature the telephony switching system operates in accordance with the first subset of the plurality of features of the first feature file.

8. The secure data authentication apparatus of claim 7, the apparatus further authenticating a source of the software file, the apparatus further comprising:
a first source signature appended to the first feature file; and
a source key located within the secure microprocessor, wherein the secure microprocessor encrypts the first hash value with the source key to generate a second source signature and the secure microprocessor compares the first source signature with the second source signature and if the first source signature matches the second source signature the telephony switching system operates in accordance with the first subset of the plurality of features of the first feature file.

9. The secure data authentication apparatus of claim 7, further comprising:
a second feature file having a second subset of the plurality of features activated, the second feature file having a third owner signature appended thereto; wherein the secure microprocessor receives the second feature file and hashes the second feature file to generate a second hash value and encrypts the second hash value with the first owner key to generate a fourth owner signature and the secure microprocessor compares the third owner signature with the fourth owner signature and if the third owner signature matches the fourth owner signature the second feature file is written over the first feature file.

10. A method for authenticating an owner of a software file having a first identification means attached thereto for use on a computer system, the computer system comprising a secure processing means having an encryption algorithm and a key, the method comprising:
initiating the computer system;
hashing the software file within the secure processing means to generate a first hash value;
encrypting the first hash value with the key to generate a second identification means; and
comparing the first identification means with the second identification means and if the first identification means matches the second identification means the computer system accepts the software file as being authenticated for the owners use.

11. A method for authenticating an owner of a software file having a first owner signature appended to the software file, for use on a computer system having a secure processing device to generate an authorization signal, the secure processing device comprising a security routine, an encryption algorithm and a first owner key, the process comprising:
receiving the software file by the computer system and sending the software file to the secure processing device;
hashing the software file to generate a first hash value;
encrypting the first hash value within the secure processing device with the first owner key to generate a second owner signature; and
comparing the first owner signature to the second owner signature, wherein if the first owner signature and the second owner signature match the secure processing device generates the authorization signal.

12. The method for authenticating an owner of the software file of claim 11, wherein the software file further comprises a first source signature appended thereto and the secure processing device further comprising a source key; the method further authenticating a source of the software file, the method comprising:
encrypting the first hash value within the secure processing device with the source key to generate a second source signature; and
comparing the first source signature to the second source signature, wherein if the first source signature and the second source signature match the secure processing device generates the authorization signal.

13. The method for authenticating an owner of the software file of claim 11, wherein the secure processing device further comprises a first key exchange key, the method further comprising:
receiving a key exchange request by the secure processing device, the key exchange request including an encrypted second owner key and having a first key exchange signature appended thereto;
hashing the key exchange request to generate a second hash value;
encrypting the second hash value with the first key exchange key to generate a second key exchange signature; and
comparing the first key exchange signature with the second key exchange signature, wherein if the first key exchange signature and the second key exchange signature match, the secure processing device decrypts the second owner key and replaces the first owner key with the decrypted second owner key.

14. The method for authenticating an owner of a software file of claim 13, wherein the key exchange request further comprises an encrypted second key exchange key, the authenticating method further comprising:
decrypting the encrypted second key exchange key with the first key exchange key; and
replacing the first key exchange key located within the secure processing device with the decrypted second key exchange key.

15. The method for authenticating a source and an owner of a software file of claim 13, wherein the computer system further comprises a first feature file having a first plurality of features wherein a first subset of the first plurality of features is activated and the computer system performs in accordance with the first subset of the first plurality of features, the method further comprising:
receiving a second feature file having a third owner signature appended thereto, the second feature file comprising a second plurality of features wherein a second subset of the second plurality of features is activated;
hashing the second feature file within the secure processing device to generate a third hash value;
encrypting the third hashed file with the second decrypted owner key within the secure processing device to generate a fourth owner signature; and
comparing the third owner signature with the fourth owner signature, wherein if the third owner signature matches the fourth owner signature the computer system overwrites the first feature file with the second feature file and the computer system performs in accordance with the second subset of the second plurality of features.

16. A method for authenticating a source of a software file having a first source signature appended to the software file, for use on a computer system having a secure processing device to generate an authorization signal, the secure processing device comprising a security routine, an encryption algorithm and a first source key, the process comprising:
receiving the software file by the computer system and sending the software file to the secure processing device;
hashing the software file to generate a first hash value;
encrypting the first hash value within the secure processing device with the first source key to generate a second source signature; and
comparing the first source signature to the second source signature, wherein if the first source signature and the second source signature match the secure processing device generates the authorization signal.

17. The method for authenticating the source of the software file of claim 11, wherein the software file further comprises a first owner signature appended thereto and the secure processing device further comprising a owner key; the method further authenticating a owner of the software file, the method comprising:
encrypting the first hash value within the secure processing device with the owner key to generate a second owner signature; and
comparing the first owner signature to the second owner signature, wherein if the first owner signature and the second owner signature match the secure processing device generates the authorization signal.

18. A method for authenticating a software file from a PBX manufacturer, the software file comprising a feature file having a plurality of features wherein a subset of the plurality of features are activated, the software file operating on a PBX, the PBX comprising a secure microprocessor having an encryption algorithm and a first key, the method comprising:
hashing the feature file at the PBX manufacturer to generate a first hash value;
encrypting the first hash value with a second key to generate a first signature;
appending the first signature to the feature file;
receiving the feature file and appended first signature by the secure microprocessor;
hashing the received feature file within the secure microprocessor to generate a second hash value;
encrypting the second hash value with the first key to generate a second signature; and
comparing the first signature with the second signature and if the first signature matches the second signature the PBX accepts the software file as being authenticated.
